(19) United States
(12) Patent Application Publication
(10) Pub. No.: US 2002/0109892 A1
(43) Pub. Date: Aug. 15, 2002

(54) Light transmitter and optical transfer system

(76) Inventors: Ichiro Seto, Fuchu-shi (JP); Tazuko Tomioka, Tokyo (JP); Shigeru Ohshima, Yokohama-shi (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/073,974

(22) Filed: Feb. 14, 2002

(30) Foreign Application Priority Data
Feb. 15, 2001 (JP) 2001-038022

(51) Int. Cl. H04B 10/00; H04B 10/04

(52) U.S. Cl. 359/180; 359/154

(57) ABSTRACT

The present invention provides a light transfer system comprising a plurality of slave stations each equipped with a light transmitter for outputting an optical signal corresponding to an information signal and a master station for receiving an optical multiplex signal obtained by optically multiplexing the optical signals sent from the plurality of slave stations, wherein the plurality of slave stations adjusts an amount of heat radiated from an exothermic-effect-only heat source of the optical transmitter to thereby control a wavelength of the optical signal output from a laser diode of the light transmitter.

### BACKGROUND OF THE INVENTION

1. Field of the Invention

This application is based upon and claims the benefit of priority from the prior Japanese Patent Application No. 2001-038022, filed Feb. 15, 2001, the entire contents of which are incorporated herein by reference.

2. Description of the Related Art

The present invention relates to a slave station-to-master station upward link that achieves high-quality data transfer in an optical transfer system for interconnecting a master station and a plurality of slave stations by an optical fiber.

Passive optical network systems attract much attention because they use an optical fiber, thus accommodating a subscriber's home of a fiber-to-user system in a control station (master station). (Representative examples of fiber-to-user systems are an FTTH (Fiber-To-The-Home) system, a portable phone, a radio base station (slave station) of an ITS (Intelligent Transport Systems), and the like.) The passive optical network technology is useful, simplifying and miniaturizing a transfer system. This is because the technology can be combined with the sub-carrier multiplexing technology so that a master station needs only one pair of optical transceivers and can yet perform transmission and reception with a plurality of slave stations at a time. The passive optical network system, however, generates optical beat noise when the optical signals sent from the plurality of slave stations interfere with each other on an upward link from the slave stations to the master station. FIG. 1 is a graph explaining optical beat noise. The optical beat noise is a noise component of an information signal received at the master station. It develops, as shown in FIG. 1B, in a frequency band that corresponds to a wavelength difference Δλ between optical signals A and B output from a plurality of slave stations, when the master station receives these signals at a time as shown in FIG. 1A. If the optical signals output from the slave stations are similar in wavelength, that is, if Δλ is small, optical beat noise develops near the information signal band (e.g., radio frequency band around 1 GHz or so). The optical beat noise deteriorates the transfer quality. To solve this problem, there have been proposed some methods.

Published Japanese Patent No. 3096694, for example, proposes a method of providing a noise detector at a master station. The noise detector detects presence/absence of optical beat noise. Thus, the wavelength of a light source at each slave station can be controlled to a predetermined value, thereby to preserve the transfer quality of a sub-carrier multiplexing signal. In this wavelength control method, the exothermic/endothermic effects of a Peltier heat source element is utilized to control the temperature of a laser diode provided in the slave station. The temperature control stabilizes the wavelength at a predetermined value. This method, wherein the exothermic/endothermic effects control the temperature, is disadvantageous in some respects. First, the control system is liable to oscillate due to a difference in heat transfer between the individual elements, including a laser diode package provided in the slave station. Secondly, it takes rather a long time for the temperature to become stable. Inevitably, the wavelength fluctuates, generating optical beat noise in some cases.

A Peltier element is usually applied to a device for controlling the temperature generated by the exothermic/endothermic effects. If the laser diode package is of a butterfly type, it may contain the laser diode and the Peltier element. However, the butterfly type package requires a space for disposing pins and is expensive. To reduce the size and manufacturing cost of the light transmission section, it is desirable to employ a coaxial type or a Mini-DIL (Minimum Dual-In-Line) type that has a simple configuration of packaging only the laser diode. A simple, coaxial Mini-DIL type package is sealed from the beginning. Therefore, a Peltier element cannot be incorporated into the package and must be mounted externally to the laser diode package. It is, however, difficult to sufficiently seal the externally mounted Peltier element and the packaged laser diode. Dewdrops may be formed on the Peltier element, due to intrusion of air. The Peltier element may be short-circuit, possibly to deteriorate the long-term reliability of the laser diode package.

### BRIEF SUMMARY OF THE INVENTION

An object of the present invention is to provide a light transmitter and optical transfer system that solves the above problems by suppressing the influence by optical beat noise on an upward link of a passive optical multiplex access system between a master station and a plurality of slave stations.

The light transmitter of this invention comprises a packaged laser diode (11) having a first thermal contacting portion that can thermally come in contact with the outside, and a heat source (17) of only the exothermic effect that is provided on the first thermal contacting portion and that has a second thermal contacting portion capable of coming in thermal contact with the outside.

With the present invention it is possible to suppress the influence of the optical beat noise on the transfer quality by using a simple method of controlling the wavelength of an optical signal based on a unidirectional temperature change of only the exothermic effect (not of the endothermic effect). Since wavelength control involves unidirectional temperature control, the control system is not liable to oscillate. The system can therefore reliably control the wavelength, regardless of an individual difference in heat transfer of the laser diode package. By using an exothermic-effect only as heat source, no dewdrops will be formed. This imparts a long-term reliability to the laser diode package. Furthermore, the wavelength controller has such a structure that needs only unidirectional temperature control. The circuit scale of the controller can be reduced to almost a half the scale of the conventional wavelength controller that has both exothermic effect and endothermic effect. The present invention, therefore, is useful in miniaturizing the slave stations. Moreover, the wavelength control method of the present invention can be applied to a cost-effective coaxial type or Mini-DIL type package, too, and can reduce the costs of the light transmitter.

Furthermore, the laser diode may undergo prolonged wavelength fluctuation, due to various factors such as an ambient temperature, aging, and the like. Conventionally, optical beat noise is always monitored in the master station to control the wavelengths of the slave stations to a preset value by using the exothermic and endothermic effects. The noise is so monitored in order to avoid the influence of the optical beat noise on the transfer quality against the fluctuation of wavelength. The influence of the optical beat noise can be avoided if there is provided a sufficient inter-wavelength spacing. Therefore, as in the present invention, a simple unidirectional wavelength control method can be performed to change the wavelength by using only a heat source. This provides an appropriate inter-wavelength spacing, preventing the generation of the optical beat noise. With the present invention it is possible to miniaturize the configuration of a transfer system as a simple control system to thereby enhance the reliability of the transfer system not only at the time of initial introduction but also for a prolonged term.

Furthermore, the temperature may remarkably rise around the laser diode, depending on the weather, at a slave station that is positioned outdoors, like a radio base station. In the present invention, the master station monitors the temperature of the laser diode provided in the slave station, and a desirable wavelength is preset on the basis of the temperature monitored. The wavelength is therefore controlled in a fewer steps than otherwise, readily preventing optical beat noise.

Generally, a large-power transistor is used to drive a heating element such as a heater. The large-power transistor can be a heating element, however. Hence, any heating device comprising a heater and a large-power transistor has two heat-generating parts. In the present invention, the transistor is a sole heat-generating element, which can heat the laser diode efficiently. As will be described later in “DETAILED DESCRIPTION OF THE INVENTION,” it suffices to impart a slight temperature change of a few degrees Centigrade, to the laser diode in the present invention. Thus, a small transistor with a little power dissipation can control the wavelength to avoid the occurrence of optical beat noise. Furthermore, the transistor is sealed and is not oxidized.

Furthermore, the laser diode provided in the coaxial type package used in the present invention can transfer heat to a flange to easily change the temperature of the laser diode in the package. The flange has a relatively large area and can improve the heat transfer efficiency. The flange therefore serves to change temperature, while preventing power dissipation. Moreover, the coaxial type package is simpler in configuration and less expensive than the butterfly type package.

The present invention utilizes both an optical sub-carrier multiplexing access and a passive optical network. This enables each slave station to transfer a CW (Continuous Wave) optical signal to the master station even if no information signals are is present. Optical beat noise can therefore be always monitored. Even in such a system that transfers a busting modulation signal like a radio signal, the optical beat noise can be always suppressed to preserve a high transfer quality.

In the present invention, a simple method of controlling the wavelength of an optical signal in accordance with an exothermic-effect-only unidirectional temperature change can be employed to suppress the influence of the optical beat noise on the transfer quality. Wavelength control involves unidirectional temperature control. Therefore, the control system is not liable to oscillate, enabling controlling the wavelength in a stable manner independently of an individual difference in heat transfer including that of the laser diode package. The exothermic-effect-only wavelength control of this invention can be applied even to a laser diode contained in a coaxial type or Mini-DIL type package that cannot be integrated with a Peltier element and can reduce the manufacturing cost of the optical transfer section. The wavelength controller such a small circuit only needs unidirectional temperature control. The size of the controller can therefore be reduced to almost half the size of the conventional wavelength controller that utilizes both the exothermic and endothermic effects. The present invention, therefore, is useful also in miniaturizing the slave stations.

Furthermore, in a passive optical network, the wavelengths of the slave stations need not be evenly spaced from each other but only need to have an inter-wavelength spacing of at least 0.16 nm. A small transistor of less power dissipation may be used as a heat-generating element, instead of a large-scale heater or the like. If so, heat generation will take place at one point only. In this case, the laser diode is heated efficiently. Moreover, dewdrops will not form on the transistor, which is completely sealed.

The present invention can therefore provide a wavelength control system that has a high reliability for a long term, that has a simple configuration, and that can save power dissipation efficiently.

### BRIEF DESCRIPTION OF THE SEVERAL VIEWS OF THE DRAWING

FIGS. 1A and 1B are graphs for explaining optical beat noise;

FIG. 2 is a schematic block diagram for showing an optical transfer system according to a first embodiment of the present invention;

FIG. 3 is a schematic block diagram for showing a wavelength controller 18;

FIG. 4 is a circuit diagram for showing the wavelength controller 18 where a transistor is used as an exothermic-effect-only heat source;

FIG. 5 is a schematic configuration diagram for showing a light transmitter 10 where a coaxial type package is used to contain a laser diode;

FIG. 6 is a schematic configuration diagram for showing the light transmitter 10 where a Mini-DIL type package is used to contain the laser diode;

FIG. 7 is a schematic block diagram for showing the optical transfer system according to a second embodiment of the present invention;

FIG. 8 is a schematic block diagram for showing the optical transfer system according to a third embodiment of the present invention;

FIG. 9 is a flowchart for showing a wavelength control algorithm of the present invention; and

FIG. 10 is a graph for showing a relationship between an inter-wavelength spacing and optical beat noise.

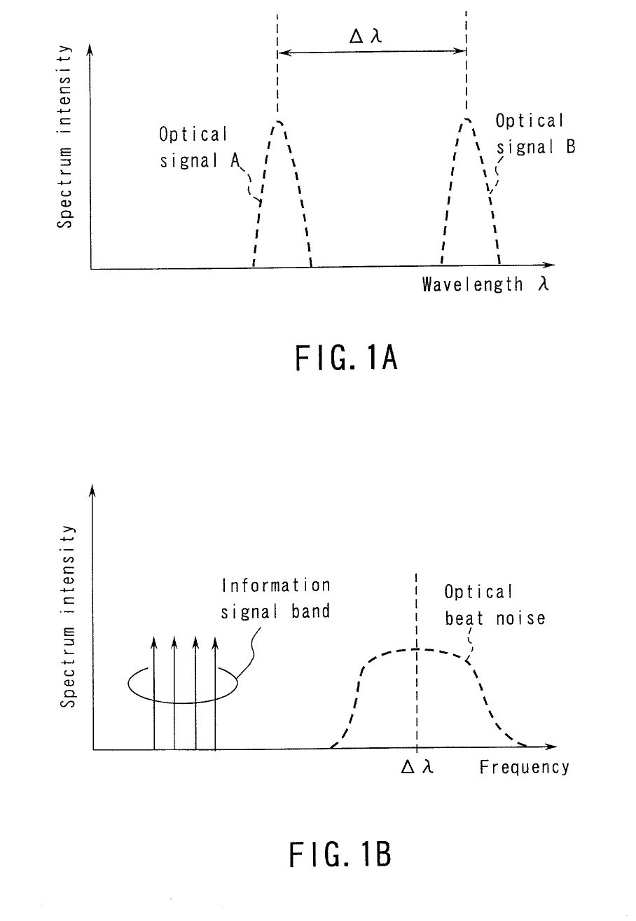

### DETAILED DESCRIPTION OF THE INVENTION

Embodiments of the present invention will be described, with reference to the drawings. The embodiments comprise three slave stations each. Nonetheless, it suffices if each embodiment has at least two slave stations.

First Embodiment

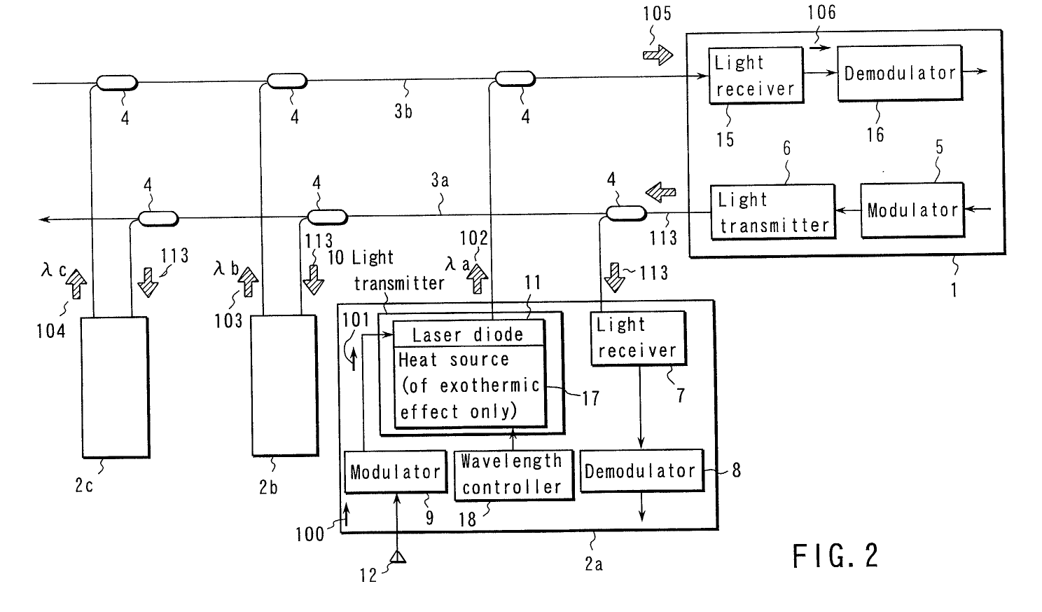

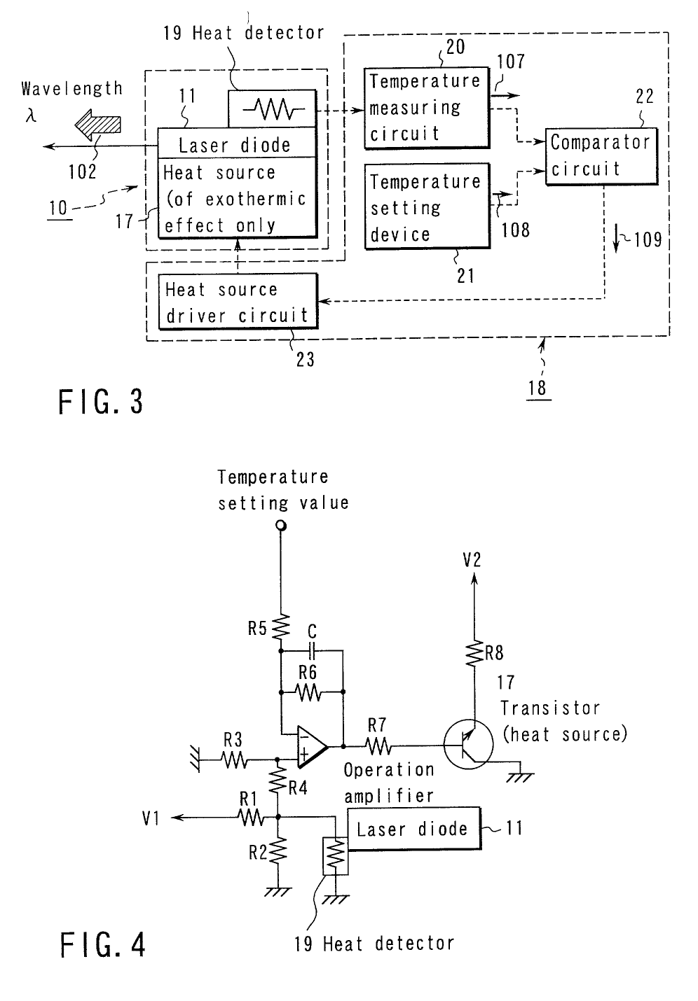

FIG. 2 shows a schematic block diagram of an optical transfer system according to the first embodiment of the present invention. As FIG. 2 shows, an optical fiber 3 connects a master station 1 to slave stations 2a to 2c. In this embodiment, a downward link from the master station 1 to the slave stations 2 and an upward link from the slave stations 2 to the master station 1 consist of bus type optical fibers 3a and 3b, respectively. They may be replaced by optical fibers of a star type, tree type or even any other type, provided that they serve to construct a passive optical network. The embodiment is described with reference to the upward link, where optical beat noise is a problem. In the slave station 2a, a modulator 9 converts an information signal 100, which is to be transferred to the master station 1, into a modulated signal 101. The signal 101 is applies it to the laser diode 11 provided in a light transmitter 10. The information signal 100 may be a radio signal received at an antenna 12. In this case, the modulator 9 operates as a frequency converter or a level adjuster. The laser diode 11 transfers, to the master station 1, an optical signal 102 which is directly modulated with the modulated signal 101 and has a wavelength λa assigned to the slave station 2a beforehand. Likewise, the slave stations 2b and 2c output optical signals 103 and 104 having wavelengths λb and λc, respectively. These optical signals 102, 103, and 104 are each supplied through an optical coupler 4 to the optical fiber 3b and are optically modulated into optical signals 105. A light receiver 15 provided in the master station 1 receives the optical signals 105, providing a received signal 106. In the master station 1, a demodulator 16 modulates the signal 106, thus receiving the information signal 100 from the slave stations 2. If the respective wavelengths λa, λb, and λc of the optical signals 102, 103, and 105 sent from the slave stations 2 are similar to each other, optical beat noise is generated in a band of the received signal 106. The optical heat noise will deteriorate the transfer quality of the information signal sent from each slave station. It is, therefore, necessary to control the respective wavelengths λa, λb, and λc of the optical signals 102, 103, and 104, prevent the optical beat noise. To this end, each slave station 2 has a wavelength controller 18. FIG. 3 is a schematic block diagram of the wavelength controller 18.

In the slave stations 2, an exothermic-effect-only heat source element 17 is used as wavelength control means for the laser diode 11. The exothermic-effectonly wavelength control method will be described with reference to a proportional control taken for example. As FIG. 3 shows, a heat detector (e.g., thermister) 19 surrounds the laser diode 11 to detect the temperatures of the exothermic-effect-only heat source 17 and laser diode 11. The light transmitter 10 comprises the laser diode 1, the heat source 17, and a thermister 19. A temperature measuring circuit 20 determines the temperature of the laser diode 11 from a change in the resistance of the thermister 19. The circuit 20 generates a temperature signal 107 that represents the temperature thus determined. A comparator circuit 22 compares the temperature signal 107 with a preset temperature value 108 supplied from a temperature setting device 21 and generates an error signal 109 representing the difference between the signal 108 and the value 108. The error signal 109 is supplied to a heat source driver circuit 23. The heat source driver circuit 23 controls the amount of heat that the heat source 17 generates, in accordance with the magnitude of the error signal 109, to thereby stabilize the temperature of the laser diode 11 at the preset temperature value 108. The thermister 19 is adhered to, for example, the flange of the laser diode 11. It is so position as to easily detect the temperature of the laser diode. Preferably, the heat source 17 also is adhered to the flange of the laser diode 11 to reduce the thermal resistance component and, ultimately, to decrease the power dissipation. In such exothermic-effect-only temperature control, λa, λb, and λc can be controlled not to be similar to each other, by giving them respective temperature differences. This measure taken, a temperature stability of 1.0° C. or less is achieved, controlling the wavelength λ of the optical signal 102 output from the laser diode 11 at a value not larger than 0.1 mm.

FIG. 4 is a circuit diagram of a light transmitter and a wavelength controller, where a transistor is used as the exothermic-effect-only heat source 17. A reference voltage V1, resistors R1 and R2, and the thermister 19 are used to determine the temperature of the laser diode 11 as packaged. The thermister 19 contacts a thermal contacting portion that can thermally contact , for example, the flange of the laser diode 11. The thermister 19 is therefore sensitive to a change in temperature of the laser diode 11 in the package. Moreover, resistors R3, R4, R5, and R6, a capacitor C, and an operational amplifier are used to compare the temperature of the laser diode 11 and a preset temperature value. The difference signal representing the difference between the temperature of the diode 11 and the preset temperature value is supplied to the base of the heat source transistor 17. The current flowing in the transistor 17 is changed in accordance with a resistance value of the load resistor R8 and the difference between the temperature of the laser diode 11 in the package and the preset temperature value. The generated heat of the transistor 17 is thereby controlled, whereby the temperature of the laser diode 11 is controlled. The transistor 17 is ordinarily packaged, having a thermal contacting portion that can thermally contact an external device such as a grounding electrode for heat radiation. By mounting the thermal contacting portion of this transistor and the thermal contracting portion that can thermally contact the outside of the laser diode, the temperature of the laser diode 11 can be changed to control the wavelength. Although an NPN transistor is used as the heat source 17, any other electronic circuit device, such as a PNP transistor or an FET, if it generates heat. If the laser diode 11 has a coaxial type package, the anode of the laser diode is often electrically connected to the flange and, hence, to be grounded for stabilization of the operational characteristics thereof. For this purpose, the transistor can be easily mounted in contact with the flange having a relatively large area. Since the flange has good heat transfer properties, a change in temperature can be readily transferred. This helps to change the wavelength with high efficiency.

The embodiment described is a proportional temperature control type. Nonetheless, any other type may be employed in the present invention. For example, an On-Off control type may be used, which can easily turns the heat source on and off. By On-Off type control, the heat source is turned off if the temperature measurement 107 is higher than the preset temperature value 108, and turned on if the temperature measurement 107 is lower than the preset temperature value 108. Hysteresis may be imparted to the heat source driver circuit 23 by, for example, enhancing the operation sensitivity, a time delay may be imparted to the circuit 23 in consideration of the capacity of the heat source. The heat source is thereby prevented from being turned on and off too frequently. In addition, a pulse interval control type is available, which is a variant of the On-Off control type. In the pulse interval type control method, On/Off switching interval and frequency are changed to achieve control nearly equal to proportional control. Any other temperature control method may be employed.

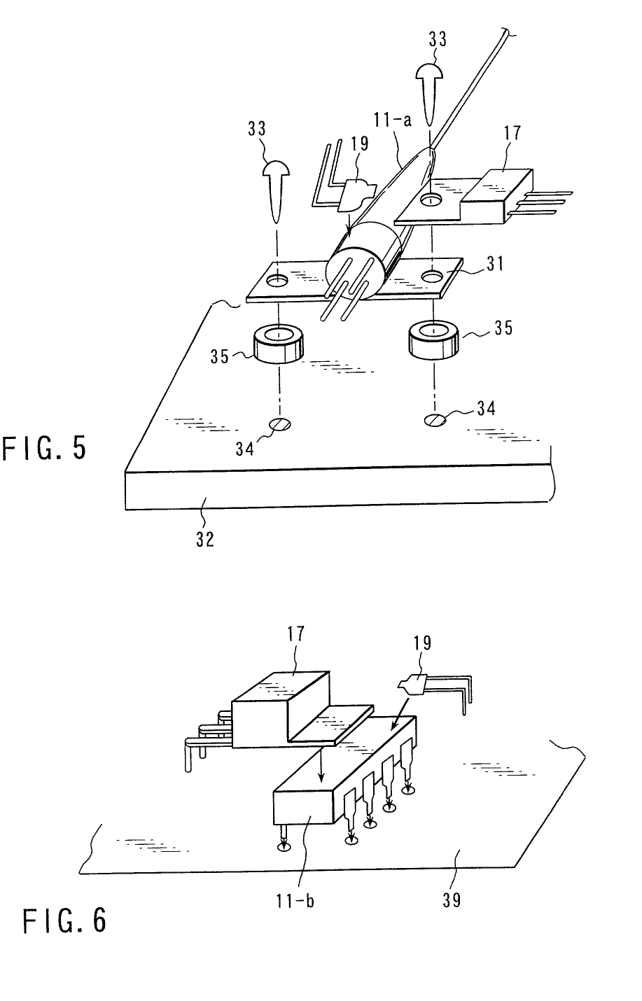

FIGS. 5 and 6 are schematic configuration diagrams of the light transmitter 10. The transmitter 10 comprises a transistor as the exothermic-effect-only heat source 17. FIG. 5 shows a specific example, in which a coaxial type package 11-a contains the laser diode. As FIG. 5 shows, the thermal contacting portion (flange) 31 of the coaxial type laser diode 11-a is fitted in a cabinet 32 with a screw 33 that is driven in a screw hole 34. The screw 33 is made of nonconductive material such as resin or acrylic. A nonconductor 35 likewise made of resin, acrylic, or Teflon, is provided between the cabinet 32 and the flange 31, suppressing heat conduction to the cabinet 32. Moreover, the thermal contacting portion (i.e., heat conducting portion, such as heat radiating portion) of the heat source transistor 17 is adhered to the flange 31. The flange 31 is grounded often. In view of this, it is desired that the thermal conducting portion of the transistor 17 be used as the grounding electrode. In such a configuration, the heat conduction from the coaxial type laser diode 11-a to the cabinet 32 can be controlled, whereby the heat of the transistor 17 is effectively conducted to the coaxial type laser diode 11-a, with a minimum dissipation of heat. It is, therefore, possible to change the wavelength of the coaxial type laser diode 11-a using a transistor with small power dissipation. Additionally, the flange 31 may be adhered to the thermister 19 for measuring the temperature of the coaxial type laser diode 11-a. Then, the thermister 19 can readily respond to changes in temperature of the coaxial type laser diode 11-a, to measure the temperature accurately.

FIG. 6 shows a specific example having a Mini-DIL type package 11-b that contains a laser diode. The laser diode 11-b has a heat-conducting portion on a second main surface that is opposite to a first main surface facing a board 39. The heat source transistor 17 and the thermister 19 are fixed to the heat-conducting portion. The Mini-DIL type laser diode 11-b is disposed between the board 39 and the transistor 17. The board 39 can radiate heat efficiently. The heat of the transistor 17 can therefore be conducted to the Mini-DIL type laser diode 11-b, dissipating much heat to the board 39.

In the exothermic temperature control method, the temperature of the laser diode 11 cannot be stabilized but to the preset temperature value higher than an ambient temperature of the laser diode 11. The method differs, in this respect, from the exothermic-and-endothermic-effects control method. The exothermic-effect-only temperature control method according to this embodiment will be described below in detail.

If the preset temperature value 108 is sufficiently higher than the ambient temperature of the slave station 2, the temperature of the laser diode 11 will follow the preset temperature value 108. If the ambient temperature of the slave station 2 is higher than the preset temperature value 108, the temperature of the laser diode 11 will follow the ambient temperature. The temperature of the laser diode 11, therefore, deviates from the preset temperature value 108 and is no longer subjected to wavelength control. The temperature 107 measured agrees with the preset temperature value 108 if subjected to the wavelength control. If not subjected to the wavelength control due to a rise in ambient temperature of the slave station 2, the temperature 107 is that of the laser diode, which has followed the ambient temperature. The ambient temperature is considered nearly equal to the temperature measured of the laser diode 11. The state of wavelength control can be determined from the relationship between the preset temperature value 108 and the temperature 107 measured. These two wavelength states are set in the wavelength control of the present invention. The wavelength control can therefore be performed in several ways.

The wavelength control aims at avoiding the influence of the optical beat noise. Hence, no problems will arise even if the wavelength λ can no longer controlled and may depend on the ambient temperature, provided that the optical beat noise imposes no influence on the signal 106 received. The wavelengths of the optical signals 102 may be close to each other and it may be necessary to conduct wavelength control to avoid the influence of the optical beat noise. In this case, the wavelength controller 18 needs to set the preset temperature value 108 higher than the temperature 107 actually measured.

There is another wavelength control method, in which the preset temperature value 108 is sufficiently higher than the ambient temperature of the laser diode. This method can prevent the laser diode 11 from getting out of wavelength control. If the slave station 2 is installed indoors and the ambient temperature is therefore stable, the temperature of the laser diode 11 can be easily stabilized at the preset temperature value 108. In view of this, very different wavelengths λ may be set for the slave stations 2 at the initial operation of the system or at every inspection thereof. Then, no optical beat noise may appear in the band of the received signal 106.

However, it is not rare in many cases for the laser diode 11 to have its oscillation wavelength λ changed due to aging. Moreover, when the slave station 2 is installed outdoors, the temperature of the laser diode 11 may greatly change due to fluctuations in ambient temperature of the slave station owing to the weather. A second embodiment can performs a wavelength control method for providing high reliability against the fluctuations in wavelength owing to such factors is given by.

Second Embodiment

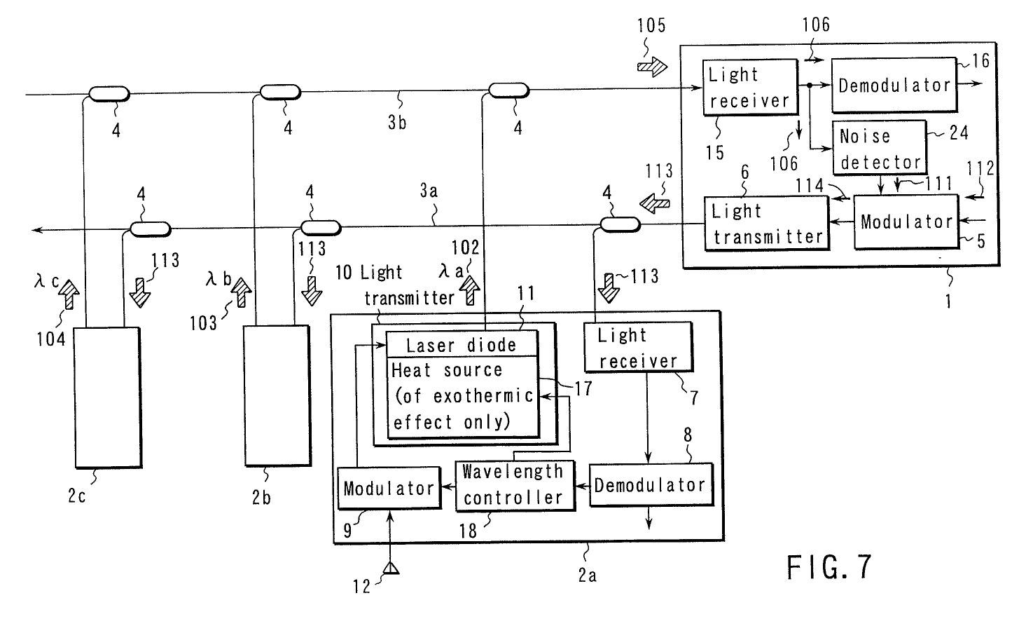

FIG. 7 shows a schematic block diagram of an optical transfer system according to the second embodiment. The same elements as those of the first embodiment are indicated by the same reference numerals. The second embodiment provides a method for detecting at the master station 1 whether the optical beam noise is present so that based on the detected information the wavelength λ of each slave station 2 may be controlled.

At the master station 1, the received signal 106 received at the light receiver 15 is partially input to a noise detector 24. The noise detector 24 detects the presence or absence of the optical beat noise contained in received signal 106. Assume that a change in ambient temperature or aging has such an effect that the wavelengths of any of the received signals 102-104 get close to each other gradually to thereby generate optical beat noise. The optical beat noise, therefore, is generated in a high frequency band toward the band of the information signal of the received signal 106. To detect the optical beat noise before it deteriorates the transfer quality of the received signal 106, the noise detector 24 monitors the presence or absence of the optical beat noise with reference to a noise-amount threshold value preset in a band higher than that of the optical beat noise. If there is no optical beat noise detected, control is not conducted on the wavelength λ of the laser diode 11 of each slave station 2. If optical beat noise is detected, on the other hand, to suppress it, control is conducted on the wavelengths λ of the laser diodes 11 of the slave stations 2 independently of each other or at a time. The noise detector 24 generates a wavelength control signal 111 for controlling the wavelength of the slave station 2. A modulator 5 converts an information signal 112 on the downward link into a modulated signal and also superimposes the wavelength control signal 111 on it to provide a downward signal 114. If the information signal 112 is a radio signal, the modulator 5 conducts, for example, frequency conversion to assign the information to each slave station 2 to thereby superimpose the wavelength control signal 111 on a sub-carrier. A light transmitter 6 converts the downward signal 114 into an optical signal 113. The signal is transferred from the master station 1 to the slave station 2. The optical signal 113 is transferred to each slave station 2 via the optical 3a and the optical coupler 4.

Each slave station 2 receives at a light receiver 7 the optical signal 113 transferred from the master station 1. The light receiver 7 outputs the downward signal 114 sent from the master station 1. The signal 114 is supplied to a demodulator 8. The demodulator 8 extracts the information signal 112 and the wavelength control signal 111 from the downward signal 114. The wavelength control signal 111 is output to the wavelength controller 18. The wavelength controller 18 controls the wavelength λ of the laser diode 11 based on the wavelength control signal 111. The wavelength control signal 111 carries the information of a wavelength shift of, for example, “+0.15 nm” or “−0.10 nm”. The side of the slave station 2 controls the wavelength λ based on the wavelength control signal 111, thus avoiding the influence of the optical beat noise. As described in conjunction with the first embodiment, the wavelength shift information mentioned above may be employed if the preset temperature value 108 in the wavelength controller 18 is sufficiently higher than the ambient temperature of the slave station 2. If the slave station 2 is installed outdoors and the preset temperature value 108 is nearly equal to the room temperature, the temperature of the laser diode 11 may sometimes be higher than the preset temperature value 108. To avoid this situation, the slave station 2 is adapted to always set the preset temperature value 108 higher than the temperature measurement 107 of the laser diode 11.

Third Embodiment

If the master station 1 conducts concentrated management of the wavelengths of the slave stations, it must know the temperature of the laser diode of each of the slave stations 2 in order to control the wavelength accurately. A transfer system that enables such control is described as the third embodiment.

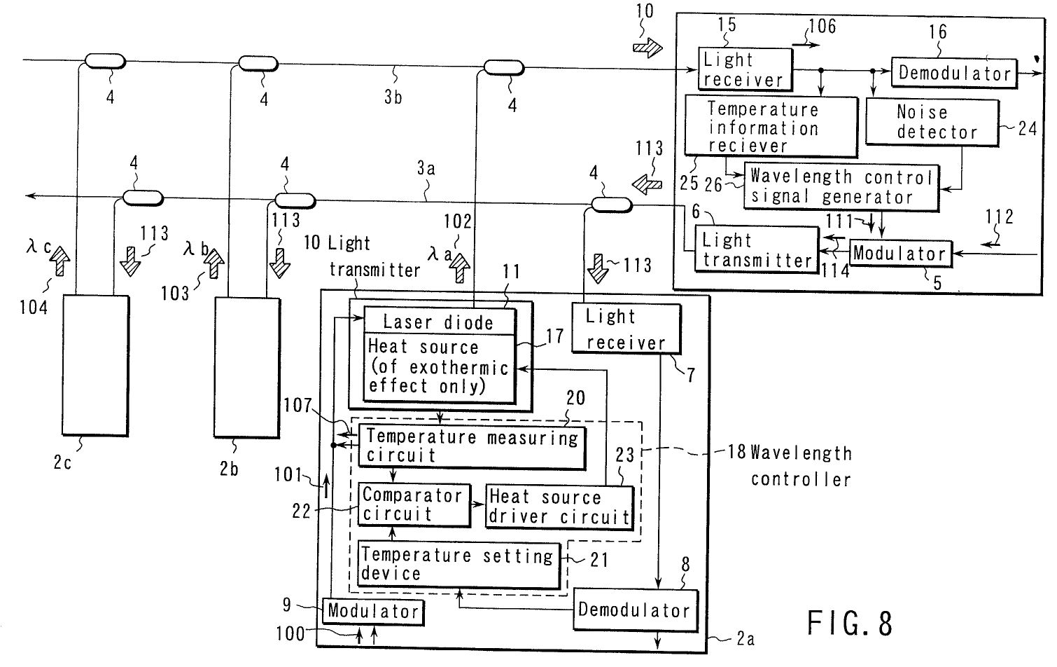

FIG. 8 shows a schematic block diagram of the optical transfer system according to the third embodiment. The slave station 2a superimposes the temperature information signal 107 sent from the temperature measuring circuit 20 on the modulated signal 101 to then use these signals 101 and 107 in order to drive the laser diode 11. The laser diode 11 outputs the optical signal 102 and transfers it to the master station 1. In the master station 1, the light receiver 15 receives the optical signal 105. The optical signals 102, 103, and 104 sent from the slave stations 2 are multiplexed to be the optical signal 105. The signal 105 is converted to a signal 106 at the receiver 15.+ The signal 106 is output as divided into three signals. The three signals are supplied to a temperature information receiver 25, the noise detector 24, and the demodulator 16, respectively. The temperature information receiver 25 extracts the temperature information signal 107 sent from each slave station 2. The noise detector 24 detects presence/absence of the optical beat noise. If the noise detector 24 detects no optical beat noise, it is unnecessary to control the wavelength of each slave station. If any optical beat noise is detected, the wavelength of each slave station 2 is controlled. A wavelength control signal generator 26 outputs the wavelength control signal 111. The signal is used to determine a preset temperature value of each slave station 2 based on the information transferred from the temperature information receiver 25 and the noise detector 24. The modulator 5 superposes the information signal 112 on the wavelength control signal 111, generating a downward signal 114, which is then transferred to the slave station 2. In this step, the wavelength control signal generator 26 knows temperature information of the slave station 2 beforehand. Therefore, the generator 26 outputs information of a preset temperature value higher than the temperature of the laser diode 11. Therefore, the situation that the ambient temperature of the slave station 2 is higher than the preset temperature value can be avoided. This prevents the wavelength controller 18 from being disabled. The wavelength λ of the slave station 2 can thereby be controlled reliably.

Moreover, since the master station 1 knows the temperature information, it can also know whether the wavelength controller 18 of each slave station 2 is functioning. This helps to achieve an advantage of easy maintenance and management.

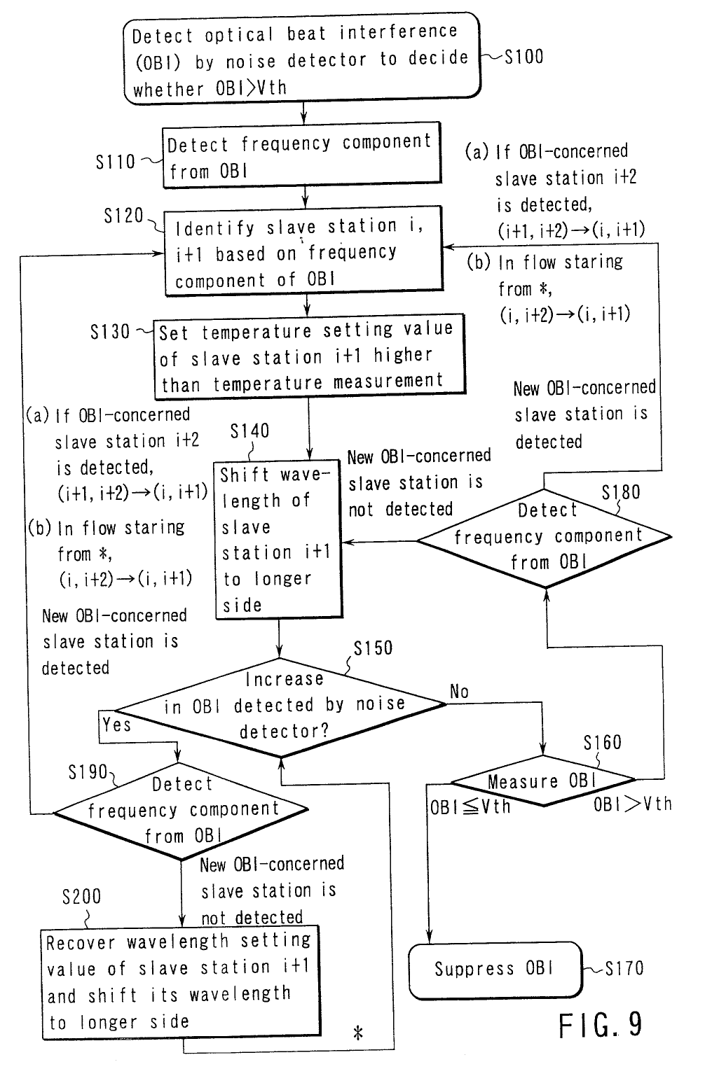

FIG. 9 shows an algorithm for controlling the wavelength between the master station 1 and the slave stations 2. A method used in this algorithm of FIG. 9 for using the noise detector 24 of the master station 1 to thereby determine any one of the slave stations 2 that is concerned with the occurrence of optical beat noise is disclosed, for example, in U.S. patent application Ser. No. 09/243121 applied on Feb. 3, 1992. A major difference is that the wavelength control flow starts with a step of shifting the wavelength to a longer side so that the wavelength can be conducted accurately even if the ambient temperature of the slave station 2 is higher than a preset temperature value.

The noise detector 24 in the master station 1 monitors optical beat noise (hereinafter called OBI: Optical Beat Interference) periodically and, if the amount of the OBI becomes more than a threshold value (hereinafter abbreviated as Vth), enters a flow for controlling the wavelength of the slave station 2 (S100). Each slave station 2 is assigned its own specific frequency band for sub-carrier multiplexing. The master station 1 detects a frequency component contained in the OBI (S110) to identify, based on the detection result, slave stations 2 i and 2 i+1 (S120). The master station 2 selects either one of these slave stations 2. It is here supposed that the slave station 2 i+1 is selected. The master station 1 sets a preset temperature value for the slave station 2 i+1 higher than the temperature of the laser diode of the slave station 2 i+1 (S130), to control the wavelength securely. The master station 1 then transfers the wavelength control signal 111 to the slave station 2 i+1 to then shift the wavelength of the slave station 2 i+1 to a longer side (S140). A wavelength shift amount dλ is 0.05 nm, for example. The magnitude of the wavelength shift amount dλ only needs to mitigate the OBI and, not to generate new OBI with other slave stations 2. As will be described later, the amount of the OBI has little effect if the inter-wavelength spacing is not less than 0.16 nm. To detect the OBI, it is optimal to first search for the spacing of 0.16 nm or so where the OBI amount starts to change. At a larger wavelength difference, the OBI amount levels off at −140 dB/Hz or less, thus making it possible to detect the occurrence of OBI. If the OBI is detected and the wavelength is shifted by dλ supposed to be 0.05 nm, the inter-wavelength spacing becomes 0.11 nm or 0.21 nm. If the inter-wavelength spacing between the slave stations 2 i and 2 i+1 becomes 0.21 nm, the OBI is suppressed down sufficiently. Additionally, if it is 0.11 nm, the OBI becomes large in amount but of such a value of −130 dB/Hz, still not goring so far as to have a catastrophic influence on the transfer quality of the received signal 106. The magnitude of d λ=0.05 nm is, therefore, appropriate but may be any other value. When the wavelength is shifted, the OBI is measured by the noise detector (S150, S160). If the OBI is decreased in level to Vth or less, the control flow ends (S170). If the OBI is indeed decreased but still not less than Vth, new OBI may have occurred with any other slave stations 2, so that the process identifies again such slave stations that are concerned with the occurrence of the OBI (S180). If no OBI-concerned slave station 2 is detected newly, the process shifts the wavelength of the slave station 2 i+1 to a longer side again (to S140). If a new OBI-concerned slave station 2 i+2 is detected, on the other hand, it is decided to be due to OBI with the slave station 2 i+1 as wavelength-shifted, the process goes along a wavelength control flow with the slave stations 2 i+1 and 2 i+2 (to S120). In FIG. 9, variables of 2 i+1 and 2 i+2 are exchanged with variables 2 i and 2 i+1 in the case (a). If the OBI is increased in level, on the other hand, there are two possible cases. First, the slave station 2 i+1 has generated OBI with a slave station 2 i+2 other than the slave station 2 i. Second, the slave stations 2 i and 2 i+1 have got close to each other in wavelength. When the OBI has increased, therefore, the process first identifies a slave station 2 concerned with the OBI (S190). If an OBI-concerned slave station 2 is detected newly, the first case applies. In the first case, it is necessary to reduce the level of the OBI of the slave stations 2 i+1 and 2 i, so that the wavelength of the slave station 2 i+1 is to be left as shifted. Then, the wavelength of the slave station 2 i+2 is to be shifted to a longer side. FIG. 9 shows a situation where the slave stations 2 i+1 and 2 i+2 are exchanged with the slave stations 2 i and 2 i+1 in the case (a) to then repeat a wavelength control flow.

If no new OBI-concerned slave station 2 is detected, the second case applies. That is, the shifted wavelength of the slave station 2 i+1 is restored to an original set value, and the wavelength of the slave station 2 i is then shifted to a longer side. This flow is indicated by an asterisk (*) in FIG. 9. For the wavelength of the slave station 2 i, the other slave station 2 i+2 may occur new OBI. If so, it is necessary to shift the wavelength of the slave station 2 i+2. FIG. 9 shows that the variable (i, i+2) is exchanged with (i, i+1) after the control flow indicated by the asterisk (*) when a new OBI-concerned slave station 2i+2 is identified. That is, the process may goes through S200 and then, for example, S150, S190, and back to S120 in this order or S150, S160, S180, and back to S120 in this order. In this case, the subject slave station changes from (i, i+2) to (i, i+1). If the process does not pass through S200, the subject slave station is changed from (i+1, i+2) to (i, i+1). The wavelength control algorithm may be any other than that shown in FIG. 9.

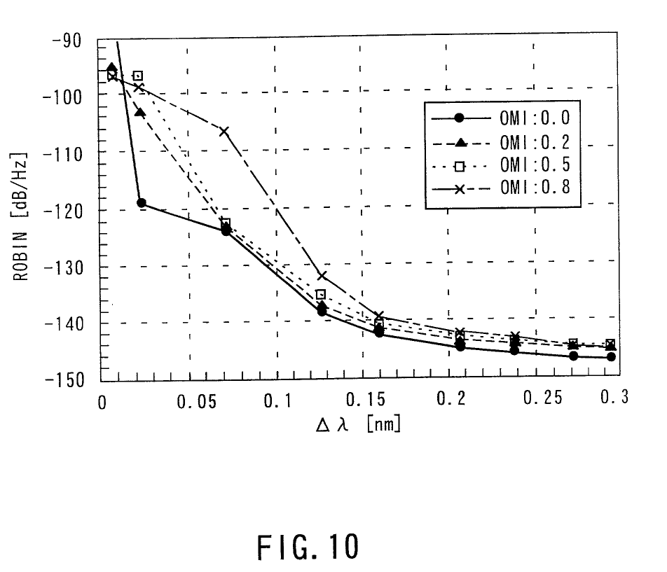

FIG. 10 shows a relationship between an inter-wavelength spacing Δλ [nm] of an optical signal output from two slave stations and ROBIN (Relative Optical Beat Interference Noise). Note that ROBIN indicates the magnitude of OBI [dB/Hz] using the OMI (Optical Modulation Index) of the laser diode as a parameter. The inventor measured ROBIN in the case where each laser diode is modulated with a sine-wave signal with a frequency of 100 MHz or HOMHz in a 1 GHz band. As seen from FIG. 10, the OBI amount increased with the decreasing amount of Δλ. If a negligible level of the influence of the OBI amount is −140 dB/Hz as a ROBIN equivalent of the laser diode, Δλ must be 0.16 nm or higher even if a change difference in the ROBIN corresponds to the OMI. The temperature dependency of the laser diode wavelength is 0.1 nm/° C. typically. Even in the case where the output wavelengths of all the laser diodes agree, the OBI can be avoided by giving a temperature difference of 1.6° C. or higher between the laser diodes. It only needs to give a temperature difference of at least 1.6° C. for two slave stations, at least 4.8° C. for four slave stations, and at least 12.8° C. for eight slave stations. Further, in a passive optical network, the wavelengths of the slave stations need not be evenly spaced. Therefore, it is sufficient for the wavelength controller to give a wavelength variation of 0.16 nm or larger in inter-wavelength spacing. In view of this, a small-power transistor can be used, which can raise the ambient temperature by 1.6° C. or higher.

The first through third embodiments described above comprise the exothermic-effect-only heat source 17 that controls the wavelength of the laser diode 11. Nonetheless, an endothermic-effect-only wavelength controller may be employed to accomplish unidirectional control of the temperature. A method of only absorbing heat from the laser diode 11 may be performed, for example, by supplying only an unidirectional current into a Peltier element whose heat-absorbing surface faces the laser diode 11. Alternatively, this method may be performed by using an inverter-equipped fan that opposes the laser diode 11 to suppress a rise in temperature of the laser diode. The heating element employed may be, for example, a nichrome wire. Furthermore, if the information signal 100 is a bursting radio signal which fluctuates in intensity, the OMI of the laser diode 11 may possibly fluctuate over a range wider than that of 0.0 through 1.0. As shown in FIG. 10, however, the OBI is not dependent on the OMI and, in fact, behaves mostly in such a way that Δλ increases from a vicinity of 0.16 nm. Thus, the first through third embodiments of the present invention are applicable.

The above-mentioned embodiments employ a coaxial-type or Mini-DIL type package containing the laser diode. Nevertheless, the present invention is not limited to the embodiments. For example, any package of a simple configuration may be applicable that packages the laser diode only.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. A light transmitter comprising:
a packaged laser diode having a first thermal contacting portion which can come in thermal contact with an external device; and
an exothermic-effect-only heat source provided on said first thermal contacting portion and having a second thermal contacting portion capable of coming in thermal contact with the external device.

2. The light transmitter according to claim 1, further comprising a heat detector provided on said first thermal contacting portion.

3. The light transmitter according to claim 1, wherein a wavelength of light oscillated by said laser diode is controlled by heat radiated from said exothermic-effect-only heat source.

4. The light transmitter according to claim 2, wherein a wavelength of light oscillated from said laser diode is controlled by heat radiated by said exothermic-effect-only heat source.

5. The light transmitter according to claim 1, wherein said exothermic-effect-only heat source is a transistor.

6. The light transmitter according to claim 2, wherein said exothermic-effect-only heat source is a transistor.

7. The light transmitter according to claim 1, wherein a package of said laser diode is a coaxial type package.

8. The light transmitter according to claim 2, wherein a package of said laser diode is a coaxial type package.

9. The light transmitter according to claim 1, wherein a package of said laser diode is a Mini-DIL type package.

10. The light transmitter according to claim 2, wherein a package of said laser diode is a Mini-DIL type package.

11. A light transfer system comprising:
a plurality of slave stations each of which is equipped with the light transmitter according to claim 1 which outputs an optical signal corresponding to an information signal, each of said plurality of slave stations including a wavelength controller which controls a wavelength of the optical signal output from the laser diode of said light transmitter by adjusting an amount of heat radiated from an exothermic-effect-only heat source of said light transmitter; and
a master station which receives an optical multiplex signal obtained by optically multiplexing the optical signals from said plurality of slave stations.

12. The system according to claim 11, wherein:
said master station is equipped with a detector which detects optical beat noise from said received optical multiplex signal;
said master station outputs a wavelength control signal to control the wavelength of the laser diode of said light transmitter based on an output result of said detector; and
said wavelength controller of each of said plurality of slave stations controls the wavelength of the optical signal output from said laser diode corresponding to said wavelength control signal received in order to suppress said optical beat noise.

13. The system according to claim 12, wherein:
said wavelength controller is equipped with a temperature measuring device which measures a temperature of said laser diode to then output a temperature information signal;
said plurality of slave stations transmits to said master station said optical signal that also corresponds to said temperature information signal;
said master station is equipped with a temperature information receiver which receives said temperature information signal; and
said master station outputs to said plurality of slave stations said wavelength control signal to control the wavelength of said laser diode, based on output results of said detector and said temperature information receiver.

14. The system according to claim 11, wherein said plurality of slave stations is each equipped with an antenna, through which said information signal is received as a radio signal.

15. The system according to claim 11, wherein:
said plurality of slave stations is each equipped with a frequency converter; and
said information signal has a frequency thereof converted by said frequency converter into a frequency band which is different with each of said plurality of slave stations, so that the optical signal corresponding to a signal having the thus converted frequency is transferred to said master station in optical sub-carrier multiplexing access.
